(19) United States
(12) Patent Application Publication
(10) Pub. No.: US 2011/0291825 A1
(43) Pub. Date: Dec. 1, 2011

(54) CAR COLLISION GLOBAL POSITIONING SYSTEM

(75) Inventor: AHMED AL-SAYEGH, KUWAIT CITY (KW)

(73) Assignee: KUWAIT UNIVERSITY, SAFAT (KW)

(21) Appl. No.: 13/205,242

(22) Filed: Aug. 8, 2011

Related U.S. Application Data
(63) Continuation-in-part of application No. 11/844,500, filed on Aug. 24, 2007.

(51) Int. Cl. B60Q 1/00

(52) U.S. Cl. 340/436

(57) ABSTRACT

The car collision global positioning system transmits an emergency alert signal to emergency authorities upon detection of a collision or other vehicular accident. A plurality of collision sensors are mounted in a body of a vehicle for detecting a vehicle collision. Preferably, each collision sensor further measures a velocity of the vehicle at a time of a collision. A collision signal is generated when at least one of the plurality of collision sensors detects the collision and the measured velocity exceeds a pre-set velocity threshold. Additionally, at least one overturn sensor is provided for generating an overturn signal when the vehicle overturns, and a deployment sensor is also provided for generating a deployment signal when an airbag of the vehicle is deployed. When at least one of the collision signal, the overturn signal or the deployment signal are generated, an emergency alert signal is generated and transmitted.

### CROSS-REFERENCE TO RELATED APPLICATION

This application is a continuation-in-part of U.S. patent application Ser. No. 11/844,500, filed on Aug. 24, 2007.

### BACKGROUND OF THE INVENTION

1. Field of the Invention

The present invention relates generally to vehicular safety, and particularly to a system for automatically generating an emergency alert signal upon detection of a vehicle collision.

2. Description of the Related Art

vehicular collisions and other accidents are typically reported by the drivers themselves, or by bystanders who witness the accident. In a collision or accident occurring in a remote location, or without bystanders, a driver in a single vehicle accident or both drivers in a dual-vehicle accident may be incapacitated and unable to call for assistance. Although automated distress beacons are known, such systems typically only transmit a basic alert signal, which must be triangulated to obtain a location. It would be desirable to be provide a vehicular alert system that automatically transmits an alert signal upon vehicular collision or accident, and which further includes positional information.

Additionally, it is often desirable for emergency personnel to have further information in advance of providing actual aid to the driver(s). Identification information, information regarding the speed of the vehicle(s) at the time of impact, and similar information may aid in the dispatch of the appropriate type of assistance.

Thus, a car collision global positioning system solving the aforementioned problems is desired.

### SUMMARY THE INVENTION

The car collision global positioning system transmits an emergency alert signal to emergency authorities upon detection of a collision or other vehicular accident. A plurality of collision sensors are mounted in a body of a vehicle. The plurality of collision sensors preferably includes first, second, third and fourth pairs of force-actuated microswitches. The first pair of force-actuated microswitches is mounted on a front end of the body of the vehicle, the second and third pairs of force-actuated microswitches are respectively mounted on opposing sides of the body of the vehicle, and the fourth pair of force-actuated microswitches is mounted on a rear end of the body of the vehicle. Each of the first and fourth pairs of force-actuated microswitches include a driver's side force-actuated microswitch and a passenger's side force-actuated microswitch. Preferably, each collision sensor further measures the velocity of the vehicle at the time of a collision.

A collision signal is generated when at least one of the plurality of collision sensors detects the collision and the measured velocity exceeds a pre-set velocity threshold. Additionally, at least one overturn sensor is provided for generating an overturn signal when the vehicle overturns, and a deployment sensor is also provided for generating a deployment signal when an airbag of the vehicle is deployed. When at least one of the collision signal, the overturn signal or the deployment signal are generated, an emergency alert signal is generated and transmitted, together with the position of the vehicle as determined by a global positioning system (GPS) receiver.

These and other features of the present invention will become readily apparent upon further review of the following specification and drawings.

### BRIEF DESCRIPTION OF THE DRAWINGS

FIG. 1 is flowchart showing steps in the operation of a car collision global positioning system according to the present invention.

FIG. 2 is a block diagram showing components of a car collision global positioning system according to the present invention.

FIG. 3 is a diagrammatic plan view showing positioning of collision sensors in a vehicle equipped with a car collision global positioning system according to the present invention.

FIG. 4 is a block diagram illustrating an exemplary propagation path of an emergency alert signal in a car collision global positioning system according to the present invention.

FIG. 5 diagrammatically illustrates a mercury switch in a car collision global positioning system according to the present invention.

FIG. 6 diagrammatically illustrates a force-actuated microswitch of a car collision global positioning system according to the present invention.

FIG. 7 is a block diagram illustrating system components of a car collision global positioning system according to the present invention.

FIG. 8 is a schematic diagram showing exemplary positioning of groups of collision sensors in a car collision global positioning system according to the present invention.

Similar reference characters denote corresponding features consistently throughout the attached drawings.

### DETAILED DESCRIPTION OF THE PREFERRED EMBODIMENTS

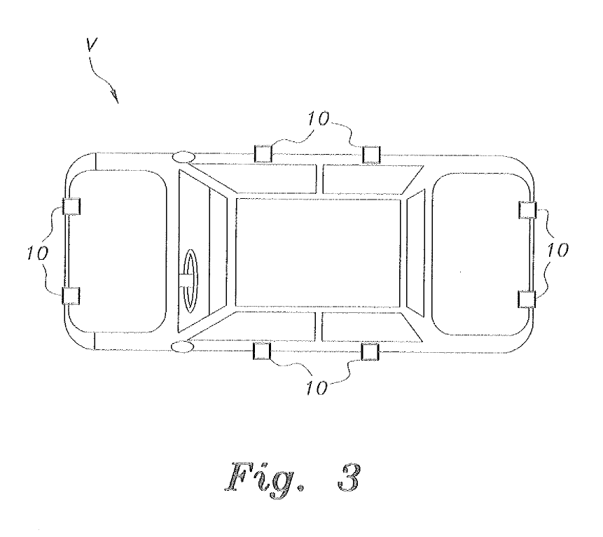

The car collision global positioning system 1 transmits an emergency alert signal to emergency authorities upon detection of a collision or other vehicular accident. As will be described in detail below, a vehicle, such as the exemplary vehicle V illustrated in FIG. 3, includes a plurality of collision sensors 10. Upon detection of a collision, the collision sensors 10 generate a collision signal, which, as will be described in detail below, actuates transmission of the emergency alert signal.

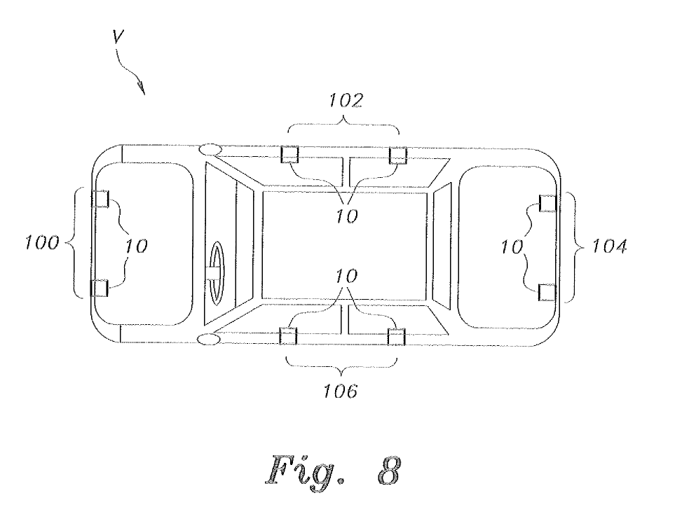

Preferably, as shown in FIG. 8, the collision sensors 10 are provided in first, second, third and fourth pairs 100, 102, 106 and 104, respectively, mounted in selected locations on the vehicle V. The collision sensors 10 preferably are force-actuated microswitches. It should be understood that any suitable type of collision sensor may be utilized. As best shown in FIG. 8, the first pair 100 of force-actuated microswitches 10 is mounted on a front end of the body of the vehicle V, the second and third pairs 102, 106 of force-actuated microswitches 10 are mounted on respective opposing sides of the body of the vehicle V, and the fourth pair 104 of force-actuated microswitches 10 is mounted on the rear end of the body of the vehicle V. Each of the first and fourth pairs 100, 104 of force-actuated microswitches 10 includes a driver's side force-actuated microswitch and a passenger's side force-actuated microswitch, as shown. For a four-door vehicle, each of the second and third pairs 102, 106 may include one microswitch 10 for each door of the vehicle. Additionally, each collision sensor 10 may measure the velocity of the vehicle V at the time of the collision, or the velocity may be determined by a GPS receiver, or may be obtained from the vehicle's engine control unit (ECU) module. Collision sensors 10 may incorporate or include any suitable type of velocity sensor or may be in communication with the vehicle's speedometer. The collision sensors 10 may be configured so that the sensors do not generate a collision signal unless the vehicle's speed exceeds a pre-set threshold, or the controller circuit 20, described below, may be programmed to ignore the collision signal unless the vehicle's speed exceeds a pre-set threshold, or both.

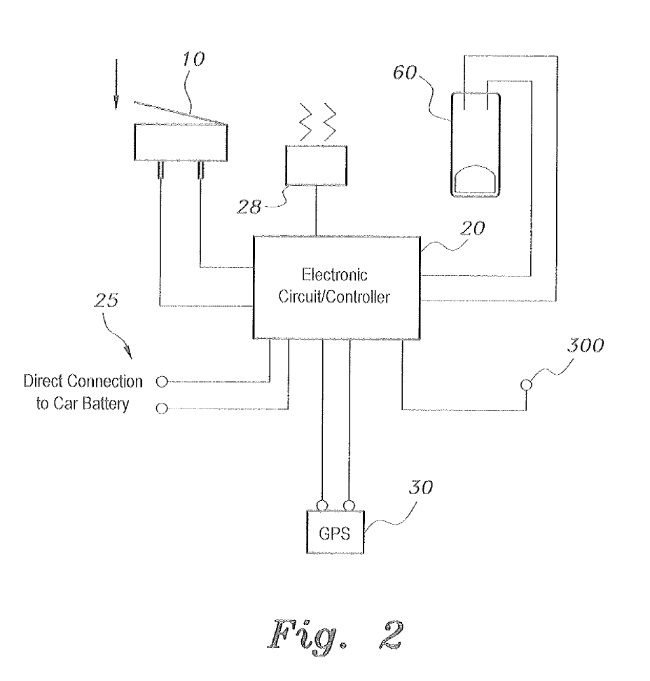

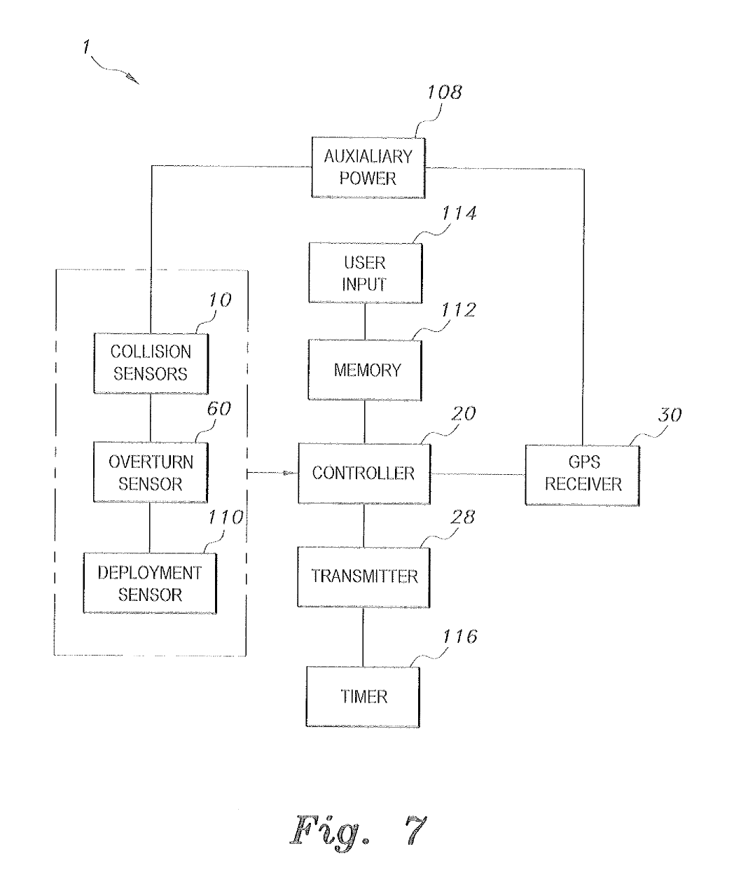

As shown in FIGS. 2 and 7, the microswitches 10 are in communication with a controller or electronic circuit 20 incorporating a controller. The controller 20 may be a computer processor, a programmable logic controller or any other suitable type of controller or processor. In FIG. 2, the controller 20 is shown as being connected to a power source 25, such as the vehicle battery. In FIG. 7, an auxiliary power source 108 is further provided. The auxiliary power source 108 may be a separate battery or the like, allowing the system 1 to continuously receive power when the primary power source (i.e., the vehicle battery) is damaged in the collision.

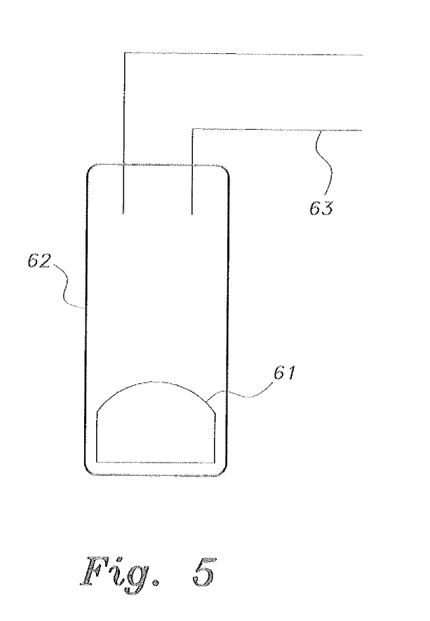

The controller 20 is in communication with a global positioning system (GPS) receiver 30, which is mounted within the vehicle and provides the position (and optionally the speed) of the vehicle V. Further, the controller 20 is either in direct communication with the vehicle's airbag system 300, as shown in FIG. 2, or, alternatively, as shown in FIG. 7, is in communication with a sensor mounted in or around the airbag system 300. A deployment sensor 110 detects actuation of the airbag. At least one overturn sensor 60 is further provided within the vehicle to detect a rollover or overturning of the vehicle. The overturn sensor 60 is preferably a mercury switch, which is also in communication with the controller 20. Upon overturning of the vehicle, the mercury switch closes, generating an overturn signal. FIG. 5 illustrates a typical mercury switch, including an enclosure or envelope 62 (typically formed from glass or the like) for containing a volume of mercury 61. Upon overturn of the vehicle, the mercury, which is electrically conductive, will roll or slide to the upper end of enclosure 62 (in the orientation of FIG. 5), thus creating an conductive bridge across terminals 63.

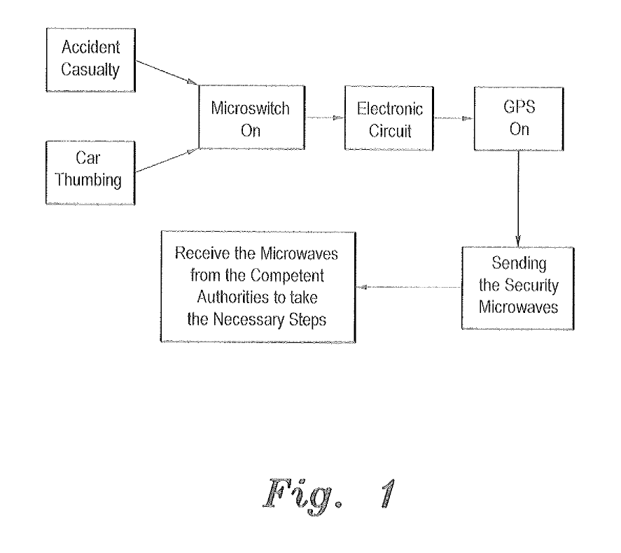

FIG. 1 illustrates the general operational flow of the system 1. When at least one of the plurality of collision sensors 10 detects a collision, and the measured velocity exceeds the pre-set velocity threshold, a collision signal is generated and transmitted to the controller 20. The pre-set velocity threshold may be stored in computer readable memory 112 associated with the controller 20 (as shown in FIG. 7), which may be any suitable type of computer readable memory. The controller 20 compares the measured velocity at the time of the collision against the pre-set velocity threshold.

Upon detection of an overturn, the overturn sensor(s) 60 generate an overturn signal, which is transmitted to the controller 20 and, similarly, upon detection of airbag deployment, the deployment sensor 110 generates a deployment signal, which is transmitted to the controller 20. Upon receipt of at least one collision signal, the overturn signal or the deployment signal, the controller generates an alert signal. The alert signal preferably includes identification information regarding the driver (which may be stored in memory 112), such as the driver's name, address, cellular telephone number or the like, and the vehicle's position at the time of collision (which is received from the GPS receiver 30). The identification information may initially be stored in memory 112 through any suitable type of user interface or input (shown generally as 114 in FIG. 7). Upon initial setup of the system 1, the system 1 optionally may dial or otherwise be placed in communication with the driver's cellular telephone, thus allowing for easy recordation and confirmation of the driver's cellular telephone number, which is then stored in memory 112.

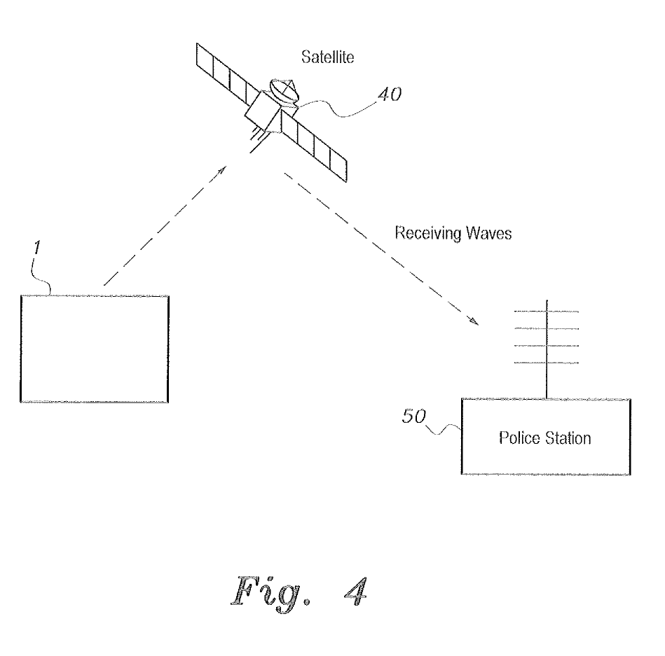

As shown in FIGS. 4 and 7, upon generation of the alert signal by the controller 20, the alert signal is fed to an onboard transmitter 28, which may be a microwave transmitter or the like, where the alert signal is transmitted. The alert signal may be directly transmitted to a receiving location 50, or may use a satellite relay 40, depending upon the nature of the transmitter 28 and the location of vehicle V at the time of the accident. The receiving location 50 may be an emergency location, or may be in communication with emergency personnel, such as police, the fire department, etc.

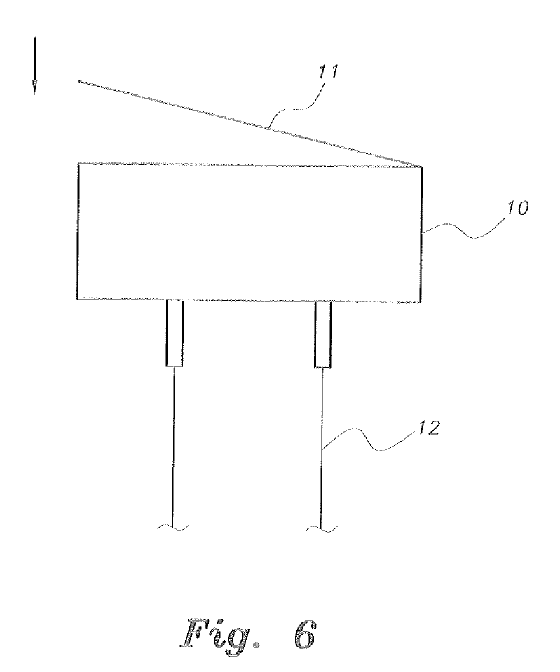

FIG. 6 diagrammatically illustrates a typical force-actuated microswitch 10. Each microswitch 10 includes a key 11, which, when closed (due to a threshold-exceeding compressive force), closes a circuit between a pair of leads 12.

The controller 20 may automatically transmit the alert signal via transmitter 28 upon receipt of at least one of the collision, overturn or deployment signals or, alternatively, may wait a threshold time period before transmitting the signal. A timer 116 may be provided, with a threshold time being stored within memory 112. For example, the threshold time may be set to thirty seconds. Upon receipt of at least one of the collision, overturn or deployment signals, the timer 116 begins counting. Only after the thirty-second threshold has been exceeded is the transmitter 28 actuated to transmit the alert signal.

This threshold period allows the user time to deliver a cancel request. If the user determines that the damage to the vehicle or himself is relatively minor, the user may enter a cancellation request via user input 114, thus preventing transmission of the alert signal. This cancellation request must be made within the pre-set threshold time. Thus, if the user is incapacitated, the signal will automatically be transmitted after the expiration of the threshold time.

It is to be understood that the present invention is not limited to the embodiments described above, but encompasses any and all embodiments within the scope of the following claims.

I claim:

1. An automotive accident alert system, comprising:
a plurality of collision sensors adapted for mounting in a body of a vehicle, the plurality of collision sensors including first, second, third and fourth pairs of force-actuated microswitches, the first pair of force-actuated microswitches being adapted for mounting on a front end of the body of the vehicle, the second and third pairs of force-actuated microswitches being adapted for mounting on opposing sides of the body of the vehicle, and the fourth pair of force-actuated microswitches being adapted for mounting on a rear end of the body of the vehicle, each of the first and fourth pairs of force-actuated microswitches including a driver's side force-actuated microswitch and a passenger's side force-actuated microswitch;
means for generating a collision signal when at least one of the plurality of collision sensors detects that the vehicle has been involved in a collision;
means for generating an overturn signal when the vehicle overturns;
means for generating a deployment signal when an airbag of the vehicle is deployed; and
means for transmitting an alert signal when at least one of the collision signal, the overturn signal and the deployment signal is generated.

2. The automotive accident alert system as recited in claim 1, further comprising means for locating the vehicle, wherein the alert signal includes location data for the vehicle.

3. The automotive accident alert system as recited in claim 2, wherein said means for locating the vehicle comprises a global positioning system receiver connected to said means for transmitting an alert signal.

4. The automotive accident alert system as recited in claim 3, wherein said means for generating the overturn signal comprises a mercury switch.

5. The automotive accident alert system as recited in claim 4, wherein said means for transmitting the alert signal comprises a microwave satellite transmitter.

6. The automotive accident alert system as recited in claim 1, wherein said means for transmitting the alert signal comprises an automatic transmitter configured for automatically transmitting the alert signal when at least one of said collision signal, said overturn signal and said deployment signal is generated.

7. The automotive accident alert system as recited in claim 1, wherein said means for transmitting the alert signal comprises a selectively operated transmitter, the selectively operated transmitter including a control circuit configured for preventing transmission of the alert signal upon receipt of a cancellation request by the driver.

8. The automotive accident alert system as recited in claim 7, further comprising a timer, wherein said selectively operated transmitter automatically transmits the alert signal if the cancellation request is not received from the driver within a pre-set time from generation of at least one of said collision signal, said overturn signal and said deployment signal.

9. The automotive accident alert system as recited in claim 1, wherein the alert signal includes driver identification information.

10. The automotive accident alert system as recited in claim 9, wherein the driver identification information includes a cellular telephone number assigned to the driver of the vehicle.

11. The automotive accident alert system as recited in claim 1, wherein each said collision sensor further comprises a vehicle speed sensing circuit, said collision sensor being configured to suppress the collision signal unless the vehicle speed sensing circuit detects a vehicle speed exceeding a pre-set threshold at the time of the collision.

12. The automotive accident alert system as recited in claim 1, further comprising a global positioning system (GPS) receiver in communication with each said collision sensor, said collision sensor being configured to suppress the collision signal unless the GPS receiver detects a vehicle speed exceeding a pre-set threshold at the time of the collision.

13. The automotive accident alert system as recited in claim 1, wherein each said collision sensor is adapted for communication with an engine control unit of the vehicle, said collision sensor being configured to suppress the collision signal unless the engine control unit detects a vehicle speed exceeding a pre-set threshold at the time of the collision.

14. The automotive accident alert system as recited in claim 1, further comprising a control circuit connected to each said collision sensor and to said means for transmitting an alert signal, said control circuit receiving a vehicle speed signal, said control circuit being configured to suppress the alert signal unless the vehicle speed signal represents a vehicle speed in excess of a pre-set threshold at the time of the collision.

15. A ear collision global positioning system, comprising:
a motor vehicle having a body;
a plurality of collision sensors mounted on the body of the vehicle, the plurality of collision sensors including first, second, third and fourth pairs of force-actuated microswitches, the first pair of force-actuated microswitches being mounted on a front end of the body of the vehicle, the second and third pairs of force-actuated microswitches being mounted on opposing sides of the body of the vehicle, and the fourth pair of force-actuated microswitches being mounted on a rear end of the body of the vehicle, each of the first and fourth pairs of force-actuated microswitches including a driver's side force-actuated microswitch and a passenger's side force-actuated microswitch;
a global positioning system (GPS) receiver mounted on the vehicle, the GPS receiver being configured to generate a signal corresponding to the vehicle's signal;
means for generating a collision signal when at least one of the plurality of collision sensors detects that the vehicle has been involved in a collision;
means for generating an overturn signal when the vehicle overturns;
means for generating a deployment signal when an airbag of the vehicle is deployed;
means for transmitting an alert signal when at least one of the collision signal, the overturn signal and the deployment signal is generated; and
a control circuit for receiving the collision signal, the overturn signal, the deployment signal, and the position signal, and for generating the alert signal transmitted by the means for transmitting, the alert signal including a collision message, an overturn message, and a deployment signal coupled with the position of the vehicle upon receipt of a corresponding signal.

16. The car collision global positioning system according to claim 15, wherein said means for generating the overturn signal comprises a mercury switch.

17. The car collision global positioning system according to claim 15, wherein said means for transmitting the alert signal comprises a microwave satellite transmitter.

18. The car collision global positioning system according to claim 15, further comprising means for determining the vehicle's speed, said control circuit being configured for suppressing the alert signal unless the vehicle speed is in excess of a pre-set threshold at the time of the collision.

19. The ear collision global positioning system according to claim 15, wherein each said collision sensor further comprises a vehicle speed sensing circuit, said collision sensor being configured to suppress the collision signal unless the vehicle speed sensing circuit detects a vehicle speed exceeding a pre-set threshold at the time of the collision.

20. The car collision global positioning system according to claim 15, further comprising means for permitting a driver of the vehicle to suppress transmission of the alert signal.
